(19) United States
(12) Patent Application Publication
(10) Pub. No.: US 2005/0247854 A1
(43) Pub. Date: Nov. 10, 2005

(54) INTEGRATED AUTO-FOCUSING DEVICE

(76) Inventor: Chih-Cheng Hsieh, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 10/904,999

(22) Filed: Dec. 9, 2004

(30) Foreign Application Priority Data
May 5, 2004 (TW) 093112662

(51) Int. Cl. G02B 27/40; G02B 27/64; G02B 7/04

(52) U.S. Cl. 250/201.2

(57) ABSTRACT

An auto-focusing device integrates a CMOS sensor and a processing circuit on a substrate. The processing circuit includes an image analyzing circuit used to analyze the imaging signal received from the CMOS sensor, and a focusing controlling circuit used to control focusing.

### BACKGROUND OF INVENTION

1. Field of the Invention

The present invention relates to an image capturing device, and more particularly, to an integrated image capturing device.

2. Description of the Prior Art

With the development of the modern information industry, image processing technology is an important research topic. Particularly, opto-electronics devices, such as optical sensors, have become the main products of many manufactures.

An optical sensor is needed in many image sensing devices, like digital cameras, scanners, etc. A CCD (Charge Coupled Device) sensor is a popular solid state sensor, which utilizes the principle of charge coupling. Generally speaking, the process of manufacturing a CCD sensor differs from the process of CMOS technology. Therefore, an optical sensing system including an optical sensor, a lens and a receiving circuit cannot be integrated together during the manufacturing process.

Another kind of optical sensor is the CMOS sensor. The advantage of a CMOS sensor is that the manufacturing process of a CMOS sensor is the same as that of CMOS circuits. Therefore, the CMOS sensor can be integrated with other CMOS circuits to form an optical sensing system.

Please refer to FIG. 1. FIG. 1 illustrates an optical sensing system 10. The optical sensing system 10 comprises a lens 14, an optical sensor 16 and an interface circuit 18. The lens 14 focuses the image to be captured on the optical sensor 16. The optical sensor is either a CCD sensor or a CMOS sensor. As shown in FIG. 1, a light source 12 forms an image on the optical sensor 16 through the lens 14. After the optical sensor 16 detects the optical signal of the image, the interface circuit 18 delivers an electronic signal corresponding to the optical signal to other processing apparatuses.

An image is to be focused on the optical sensor 16 by the lens 14 so one can get clear image signals. In a digital camera, an adjusting device automatically performs the job of focusing. In the process of making the optical sensing module 10, the lens 14 and the optical sensor 16 are fixed in the focal distance and made into a package. Therefore, a user can directly use the optical sensing module 10 without aligning the lens. The way in which an optical sensing module is made today is by manufacturing an optical sensor, the lens, and an interface circuit respectively and then combining them together. The optical sensor and the interface circuit are connected by wires, leading to higher cost, less efficient focusing and a more complicated packaging procedure.

The prior art has the following disadvantages: 1. The procedure of combining each element together is time-consuming. 2. The focusing procedure in which different modules transfer signals many times is inefficient. 3. The interface circuit and the optical sensor cannot be integrated together, which increases production time and complexity. 4. The prior art has a high system cost and consumes a great deal of power.

### SUMMARY OF INVENTION

It is therefore an objective of the claimed invention to provide an integrated image capturing device in order to solve the above-mentioned problems.

According to the claimed invention, an integrated image capturing device comprises: a substrate, a base for supporting a lens, a CMOS sensor integrated on the substrate for receiving an image signal, and a backend circuit integrated on the substrate. The backend circuit comprises an image analyzing circuit for analyzing the image signal received by the CMOS sensor and outputting an analyzed signal, and a focusing controlling circuit connected to the base and the image analyzing circuit for controlling focusing of the lens and the CMOS sensor according to the analyzed signal.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates an optical sensing system.

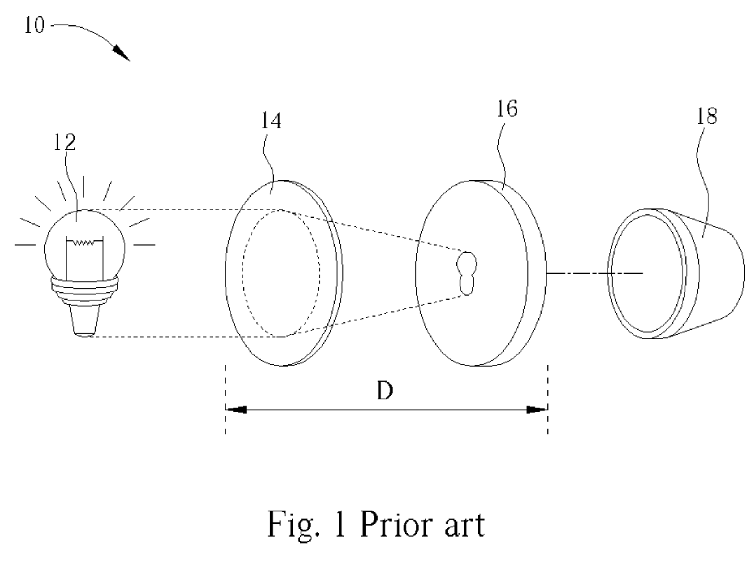

FIG. 2 illustrates the first embodiment of an integrated image capturing device according to the present invention.

FIG. 3 illustrates the second embodiment of an image capturing device according to the present invention.

FIG. 4 illustrates a focusing method with assistance of an integrated image capturing device according to the present invention.

### DETAILED DESCRIPTION

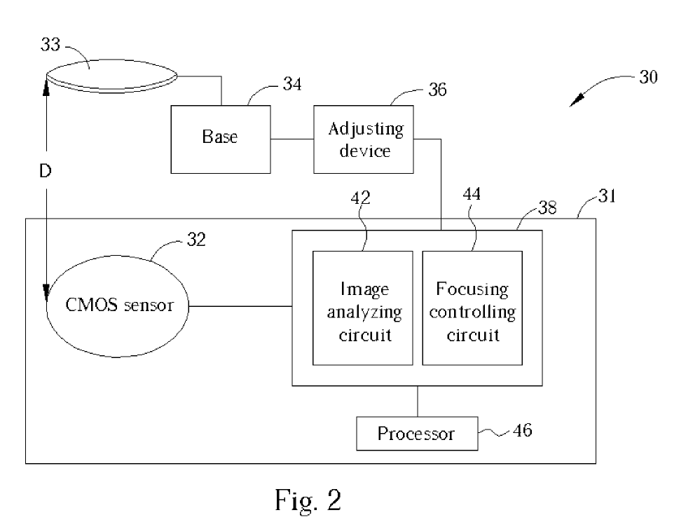

Please refer to FIG. 2. FIG. 2 illustrates the first embodiment of an integrated image capturing device 30 according to the present invention. The image capturing device 30 comprises a CMOS sensor 32, a base 34, a substrate 31, a backend circuit 38 and a processor 46. The backend circuit 38 comprises an image analyzing circuit 42 and a focusing controlling circuit 44. The base 34 comprises an adjusting device 36. The process of manufacturing the CMOS sensor 32 in the present invention is compatible with that of the backend circuit 38. They are both manufactured through CMOS technology. Therefore, the CMOS sensor 32, the backend circuit 38 and the processor 46 are integrated on the substrate 31 together. Connection of the CMOS sensor 32 and the backend circuit 38 is made by layout metal on the substrate 31, instead of wires used in the prior art. Therefore, transmission of signals between each module of the image capturing device 30 becomes simpler.

The base 34 is used to support the lens 33, and the adjusting device 36 is used to adjust the distance D between the lens 33 and the CMOS sensor 32. A light source will form its image on the CMOS sensor 32 through the lens 33. The CMOS sensor 32 receives the image signal and then passes the image signal to the image analyzing circuit 42. After the image analyzing circuit 42 analyzes the received image signal, an analyzed result is generated. The focusing controlling circuit 44 controls the adjusting device 36 to adjust the position of the lens 33 on the base 34 according to the analyzed result so as to change the distance between the lens 33 and the CMOS sensor 32.

After the image analyzing circuit 42 receives the image signal from the CMOS sensor 32, a portion of the image signal is fetched for analysis. In this embodiment, the image analyzing circuit 42 can determine the clearness of an image signal by a FD. If the FD of an image is greater, the image is clearer. Suppose a selected portion of an image signal consists of a plurality of pixels. The pixels located in Gb (or Gr) of the Color Filter are expressed as g(x,y). The gradient in the x-axis is Gx and the gradient in the y-axis is Gy. Gx, Gy, and the FD are expressed as follows:

$$Gx = g ( x , y ) - g ( x + 1 , y )$$

$$Gy = g ( x , y ) - g ( x , y + 1 )$$

$$FD = {\sum }_{x} {\sum }_{y} \{ {G}_{x}^{2} + {G}_{y}^{2} \}$$

When the distance between the lens and the optical sensor is different, the FD of the received image signal is different. When the distance between the lens and the optical sensor is the focal distance, the FD is greatest. The adjusting device 36 adjusts the distance between the lens and the optical sensor to be the focal distance according to FD.

Operation of each module in the image capturing device 30 is as follows. The focusing controlling circuit 44 controls the adjusting device 36 to adjust the distance D. When the distance is being adjusted, the image analyzing circuit 42 analyzes the FD under different distances. If the FD becomes small enough during the distance adjustment, the focusing controlling circuit 44 controls the adjustment device 36 to inversely adjust the distance between the lens and the optical sensor (shorten the increasing distance and lengthen the decreasing distance). On the other hand, if the FD becomes larger during the distance adjustment, the distance is adjusted in the same way until the FD decreases. The focusing controlling circuit 44 and the image analyzing circuit 42 cooperate with each other to locate the preferred distance. Then, the adjusting device 36 fixes the distance between the lens 33 and the CMOS sensor 32.

When the distance-adjusting module 34 performs distance adjustment, the distance between the lens 33 and the CMOS sensor 32 is adjusted using different step sizes. In the beginning, the focusing controlling circuit 44 adjusts the distance in a larger step. When the adjusting procedure undergoes the transition of the FD curve, the distance is adjusted inversely in a smaller step. The above procedures are repeated until the preferred distance is found. The adjustment using different step sizes makes the adjustment job fast and accurate.

After the focusing procedure is finished, the CMOS sensor 32 will receive a clear image signal and then pass it to the processor 46. The processor 46 is responsible for image processing, such as image compression, adjustment of image color or image brightness, or mosaic effect of an image, spray effect of an image, etc.

Notice that, the image capturing device of the present invention can be an auto-focusing system for packaging an optical sensing module in a factory, or an auto-focusing device in a digital camera. The image capturing device of the present invention is used to perform focusing procedures by adjusting the distance between a lens and a CMOS sensor. However, the focusing procedure is not limited to distance adjustment. Other methods of focusing are included in the image capturing device of the present invention.

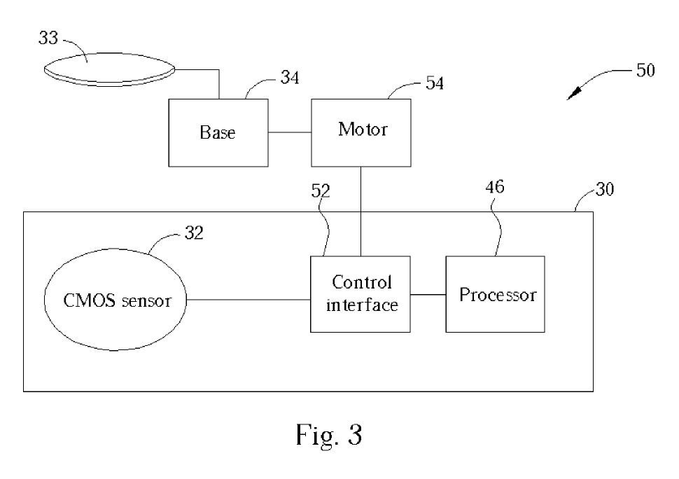

Please refer to FIG. 3. FIG. 3 illustrates the second embodiment of an image capturing device 50 according to the present invention. The image capturing device 50 comprises a CMOS sensor 32, a base 34, a motor 54, a control interface 52, a substrate 30 and a processor 46. The CMOS sensor 32, the control interface 52 and the processor 46 are integrated on the substrate 30. The base 34, having an adjusting device for adjusting the distance between the lens 33 and the CMOS sensor 32, is supports the lens 33. The CMOS sensor 32 receives an image signal and transmits it to the control interface 52. The control interface 52 stores or sends the image signal to the processor 46. The processor 46 is used to analyze the image signal, determine clearness of the image signal, calculate the FD for the image signal, and perform image compression, color adjustment, and other image effects. The analyzed result of the processor 46 is sent back to the control interface 52. The motor 54 controlled by the interface 52 changes the position of the lens 33 to make the lens 33 located at the focus of the CMOS sensor 32.

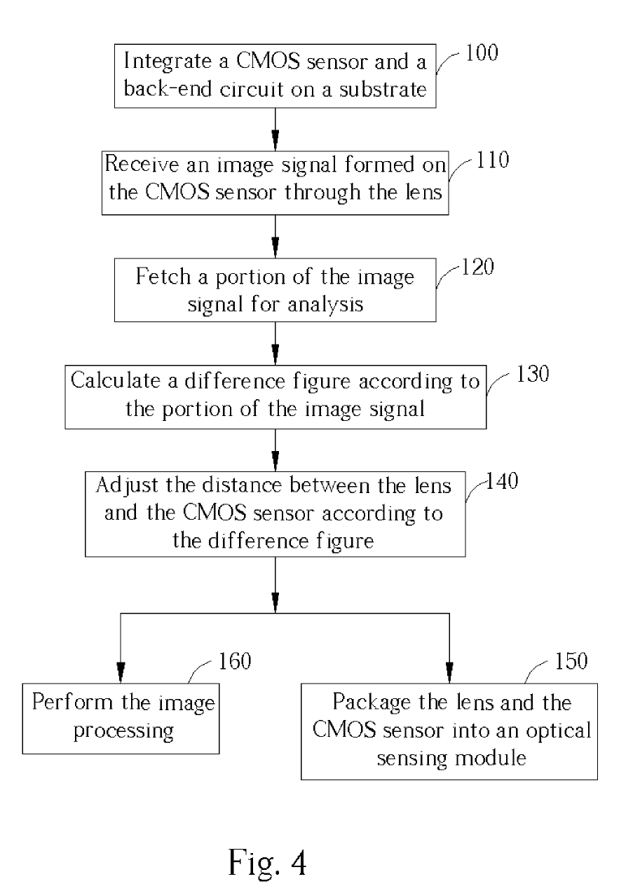

Please refer to FIG. 4. FIG. 4 illustrates a focusing method with assistance of an integrated image capturing device according to the present invention. In step 100, a CMOS sensor and a back-end circuit are integrated on a substrate. The back-end circuit comprises an image analyzing circuit and a focusing controlling circuit. The image analyzing circuit, like the image analyzing circuit 42 in FIG. 2, has the function of analyzing image signals. The focusing controlling circuit, like the focusing controlling circuit 38 in FIG. 2, outputs an analyzed signal according to the output of the image analyzing circuit so as to change the position of the lens, or change the distance between a lens and a CMOS sensor. In step 110, an image signal formed on the CMOS sensor through the lens is received. In step 120, a portion of the image signal is fetched for analysis. In step 130, a FD is calculated according to the portion of the image signal. In step 140, the distance between the lens and the CMOS sensor is adjusted according to the FD so that the distance between the CMOS sensor and the lens is the focal distance of the lens. If the present invention is applied in a digital camera, step 140 is the final step. If the present invention is for the focusing procedure in an auto-packaging apparatus, then step 150 is further performed, where the lens and the CMOS sensor are packaged into an optical sensing module. After the focusing procedure is finished, the CMOS sensor will get a clear image signal. In step 160, image processing is performed, such as image compression, adjustment of image color or image brightness, or mosaic effect of an image, spray effect of an image, etc.

When the distance adjustment is performed in step 140, the distance between the lens and the CMOS sensor is adjusted using different step sizes. In the beginning, the distance is adjusted in a larger step. When the adjusting procedure undergoes the transition of the FD curve, the distance is adjusted inversely in a smaller step. The above procedures are repeated until the preferred distance is found. The adjustment using different step sizes makes the adjustment job fast and accurate.

To manufacture a digital camera or an optical sensing module according to the prior art, an optical sensor, a lens and an interface circuit are packaged to a module. However, the procedure of packaging requires more complicated steps and increases production cost. Moreover, the procedure of combining each element together is time-consuming, the focusing procedure in which different modules transfer signals many times is inefficient, and the interface circuit and the optical sensor cannot be integrated together, which increases production time, complexity, power consumption, and cost. Compared to the prior art, the present invention integrates the backend circuit of the image capturing device and the CMOS sensor together. Therefore, transmission of electronic signals is through layout metal on the substrate, leading to highly efficient transmission of electronic signals and low system complexity. The present invention also lowers production cost and shortens the focusing time.

Those skilled in the art will readily observe that numerous modifications and alterations of the device may be made while retaining the teachings of the invention. Accordingly, the above disclosure should be construed as limited only by the metes and bounds of the appended claims.

1. An image capturing device comprising:
a substrate;
a base for supporting a lens;
a CMOS sensor integrated on the substrate for receiving an image signal; and
a processing circuit integrated on the substrate comprising:
an image analyzing circuit for analyzing the image signal received by the CMOS sensor and outputting an analyzed signal; and
a focusing controlling circuit connected to the base and the image analyzing circuit for controlling focusing of the image capturing device according to the analyzed signal.

2. The image capturing device of claim 1 further comprising an adjusting device for adjusting the distance between the lens and the CMOS sensor.

3. The image capturing device of claim 2 wherein the focusing controlling circuit is used to control the adjusting device to adjust the distance between the lens and the CMOS sensor according to the analyzed signal.

4. The image capturing device of claim 1 further comprising a processor for processing color adjustment, image effects, and image compression.

5. The image capturing device of claim 1 further comprising a memory included in the image analyzing circuit for storing the image signal received by the CMOS sensor.

6. An image capturing chip adapted for an image capturing device comprising:
a substrate;
a CMOS sensor integrated on the substrate for receiving an image signal; and
a processing circuit integrated on the substrate comprising:
an image analyzing circuit for analyzing the image signal received by the CMOS sensor and outputting an analyzed signal; and
a focusing controlling circuit connected to the image analyzing circuit for controlling focusing of the image capturing device according to the analyzed signal.

7. The image capturing chip of claim 6 further comprising an adjusting device for adjusting the distance between the lens and the CMOS sensor.

8. The image capturing device of claim 7 wherein the focusing controlling circuit is used to control the adjusting device to adjust the distance between the lens and the CMOS sensor according to the analyzed signal.

9. The image capturing device of claim 6 further comprising a processor for processing color adjustment, image effects, and image compression.

10. The image capturing device of claim 6 further comprising a memory included in the image analyzing circuit for storing the image signal received by the CMOS sensor.
